(19) United States
(12) Patent Application Publication
(10) Pub. No.: US 2013/0293880 A1
(43) Pub. Date: Nov. 7, 2013

(54) DEFECT TESTING METHOD AND DEVICE FOR DEFECT TESTING

(71) Applicants: Toshifumi Honda, Yokohama (JP); Yuta Urano, Yokohama (JP); Yukihiro Shibata, Fujisawa (JP)

(72) Inventors: Toshifumi Honda, Yokohama (JP); Yuta Urano, Yokohama (JP); Yukihiro Shibata, Fujisawa (JP)

(21) Appl. No.: 13/882,547

(22) PCT Filed: Nov. 1, 2011
(86) PCT No.: PCT/JP2011/075223

§ 371 Date: Jul. 25, 2013

(30) Foreign Application Priority Data
Nov. 1, 2010 (JP) 2010-245405

(51) Int. Cl. G01N 21/95

(52) U.S. Cl. CPC G01N 21/9501
USPC 356/237.5

(57) ABSTRACT

In a defect inspection method and an apparatus of the same, for enabling to conduct an inspection of fine defects without applying thermal damages on a sample, the following steps are conducted: mounting a sample on a rotatable table to rotate; irradiating a pulse laser emitting from a laser light source upon the sample rotating; detecting a reflected light from the sample, upon which the pulse laser is irradiated; detecting the reflected light from the sample detected; and detecting a defect on the sample through processing of a signal obtained through the detection, wherein irradiation of the pulse laser emitting from the laser light source upon the sample rotating is conducted by dividing the one pulse emitted from the laser light source into plural numbers of pulses, and irradiating each of the divided pulse lasers upon each of separate positions on the sample, respectively.

### BACKGROUND

The present invention relates to for inspecting fine defects lying on a sample surface and for determining a kind of the defect and a size of the defect to be outputted, and also an apparatus for the same.

In a production line of a semiconductor substrate or a thin-film substrate, etc., an inspection is made on the detects lying on the surface of the semiconductor substrate or the thin-film substrate, for the purpose of maintaining/improving the yield rate of products. As the conventional technology relating to the defect inspection are already known the following: Japanese Patent Laying-Open No. Hei 9-304289 (1997) (Patent Document 1); Japanese Patent Laying-Open No. 2006-201179 (2006); U.S. Patent Application Publication No. 2006/0256325 (Patent Document 3), etc. Those relates to a technology for inspecting the defects, each having a size from several tens nm up to several pm or larger than that, by irradiating an illumination light, being condensed or focused to several tens pm, upon the surface of a sample, for detecting the fine defects, and condensing/detecting the scattered lights. With a rotary movement and a translational movement of a stage for holding the sample (an inspection target) thereon, an illumination spot makes spiral scanning on the surface of the sample, and therefore an entire surface of the sample can be inspected.

Also, in the Patent Document 1 and the Patent Document 2 is mentioned a technology of detecting a component irradiating at high-angle and also a component irradiating at a low-angle of the lights scattering from the defects, and thereby classifying the defects in a kind thereof depending on that ratio detected.

Also, in the Patent Document 2 is mentioned a technology of calculating out the sizes of detect detected, upon basis of an intensity of the light scattering from that detect.

Also, in the Patent Document 3 is mentioned a control of a power of the illumination light, a scanning velocity of the illumination spot or a size of the illumination spot, during the scanning on the surface of the inspection target, for the purpose of reducing thermal damages being applied on the sample. In more details thereof, there is described that, upon assumption that the thermal damages applied on the sample can be determined upon the product of a power density of illumination to be irradiated and an irradiating time thereof, the power of the illumination light, or the scanning velocity of the illumination spot, or the size of the illumination spot is changed depending on a radius position on the sample under the scanning, so that the product does not exceed a predetermined constant value.

Also, as a technology for detecting the entire surface of the sample in a short time-period is known U.S. Pat. No. 6,608,676 (Patent Document 4), wherein an illumination is made in a wide range on the sample by a Gauss beam, elongating in one direction, while detecting the illumination region, en bloc, with using a detector having plural numbers of pixels, such as, a CCD, etc.

Also, in Japanese Patent Laying-Open No. 2007-85958 (2007) (Patent Document 5) is mentioned a technology for reducing the damages on a sample by dividing an optical path; i.e. dividing a pulse with using the difference in length between the optical paths, since many of high-output lasers are those of a type of pulse generation laser, and therefore for reducing the thermal damages on the sample due to an abrupt increase of temperature of the sample upon such instantaneous light generation.

Also, in the specification of U.S. Pat. No. 7,397,557 (Patent Document 6) is already known a technology of inspection by detecting the scattered lights from many directions, while scanning a laser spot with using an AO polarizer.

### SUMMARY

For the defect inspection to be applied in steps for manufacturing the semiconductor, etc., are required the followings: detecting a fine defect(s); measuring size of the detect detected with high accuracy; inspecting the sample in a non-destructive manner (or, without change in quality of the sample); always obtaining a constant inspection result (a number of pieces, a position, a size, and a king of the defects), when detecting the same sample; and inspecting a large number of samples within a predetermined constant time-period, etc.

With the technologies mentioned in the Patent Documents 1, 2 and 4, since the lights scattering from the defects are extremely weak, relating to the fine defect being equal to or less than 20 nm in the size thereof, in particular, therefore, a detect signal is buried within noises generating due to the scattered lights on the sample surface, noises of the detector, or noises of a detector circuit; i.e., detection is impossible. Or, when increasing the power of illumination for avoiding this, then an increase of temperature of the sample comes to be large due to the illumination light thereon, then the thermal damages are generated upon the sample. Alternately, for avoiding this, when the scanning velocity is lowered down on the sample, an area or region on the sample, in which the inspection can be made within a certain time-period, or a number of the samples is reduced. With those mentioned above, it is difficult to detect the fine defects at high-speed with avoiding the thermal damages therefrom.

On the other hand, the technology described in the Patent Document 3 mentioned above is that for aiming reduction of the thermal damages in the vicinity of a center of the sample, in comparison with that of the conventional technologies mentioned above, by changing the illumination power in relation to the radius position on the sample, or to increase sensitivity in the defect detection in an outer peripheral portion of the sample, while suppressing the thermal damages in the vicinity of the center of the sample down to be equal to that of the conventional technologies. However, this technology has the following problems, since it is made upon an assumption that the thermal damages are in relation to the product between the power density of illumination and the irradiating time thereof.

First of all, since no consideration is paid upon influences of thermal diffusion from the illumination spot in an estimation of the thermal damages, then the thermal damage, in particular, at the central portion of the sample, where the irradiation time is long, results to be estimated be much excessive than an actual one. For this reason, the illumination power is lowered down, at the central portion of the sample, much more than that necessary, then the sensitivity of defect detection is reduced.

Second, in order to generate no thermal damage on the entire surface of the sample, it is necessary to regulate the illumination power, which is applied upon such a standard that no damage is generated at the central portion of the sample where the thermal damage comes to the maximum. However, in a rotary scanning, since the scanning velocity (a linear velocity) is zero (0) at the central portion of the sample, the irradiation time diverges to infinity on the calculation thereof, i.e., the thermal damage cannot be estimated in quantity thereof, upon the assumption mentioned above, and it is impossible to regulate or control the illumination power. On the contrary, for assuring that no thermal damage is generated at the central portion, it is necessary to regulate the illumination power down to zero (0); in other words, it is impossible to make the inspection at the central portion.

Third, in case of the pulse laser, the time duration of the pulse is around 15 ps, in many cases, and when rotating the sample, such as, a wafer having a diameter of 300 mm, at about 1,000 rpm, for example, the distance of movement of the sample during this 15 ps is only 0.23 nm, approximately, on the outer periphery thereof; i.e., it can move by only the distance being extremely small comparing to an optical dissolution power.

For this reason, the area, upon which the irradiation is made by one time of pulse irradiation is almost determined, not the moving velocity of the position where the illumination is irradiated, but an area of the beam spot. For this reason, the damage upon the sample due to an instantaneous increase of temperature is hardly changed depending on the radius position of the sample.

Fourth, when the illumination power comes up so that the thermal damage is generated even on the outermost periphery of the rotating sample, then it is impossible to input an illumination power more than that.

According to the invention described in the Patent Document 5, the optical path is divided into plural numbers thereof, by means of a polarized light beam splitter, and this light is guided into the optical paths, each having different optical length from each other, and this light is guided to the polarized light beam splitter, again, with the time difference generated when it passes through those optical paths; i.e., the pulse is divided by shifting the timings when the pulses arrive at where the optical paths are combined. However, with this method, it is difficult to make the beam spot small. Unless the lights, after passing through the different optical paths, illuminate the same position, respectively, they result into be a large beam spot, seeing them entirely, even if each illumination of the optical paths forms a small beam spot. For the optical paths, divided once, to return to the same optical path, there is necessity of providing a large numbers of mirrors, and in general, an angular shift may be generated in an optical axis of the beam, when returning them back to the same optical path by means of the polarized light beam splitter. For this reason, the lights after passing through the respective optical paths illuminate the separate positions, respectively, and as a result thereof, it is impossible to obtain the small beam spot. Since an amount of lights obtained from the defects can be determined by an amount of lights per a unitary area, then enlargement of the beam spot results into lowering of capacity or performance of detecting the defects.

According to the invention described in the Patent Document 6, although not relating to the technology invented by taking the thermal damages into the consideration thereof; however, with applying this technology, it is possible to reduce the illumination power per an area by deflecting the beam spot at high-speed, and thereby reducing the thermal damages, but because of the same reason to that of the Patent Document 3, it is impossible to reduce the thermal damages when applying the pulse laser therein. Further, even in case of a continuous oscillating laser, in particular, in case where the inspection cannot be made with sufficient sensitivity because of shortage of the illumination power to be applied due to the thermal damages, since a sufficient amount of the scattered lights cannot be obtained from the defects, even if moving the beam spot at the velocity higher than the moving speed of the sample, and therefore it is impossible to achieve the inspection with high sensitivity.

An object of the present invention is to provide a defect inspection method for enabling detection of fine defects without giving the thermal damages on the sample, with scanning the entire surface of the sample within a short time-period, and an apparatus is for that.

For dissolving such problems as mentioned above, according to the present invention, there is provided a defect inspection apparatus, comprising: a table which mounts a sample thereon and being able to rotate; a laser light source which emits a pulse laser; an illumination optical system which divides one pulse of the laser pulse emitted from the laser light source, thereby to irradiate upon the sample mounted on the table means; a detection optical system which detects a reflected light from the sample, being illuminated by irradiation of pulse lasers, which are divided into plural numbers thereof by dividing the one pulse by the illumination optical system; a signal processor which processes an output signal from the detection optical system detecting the reflected light; and an output unit which outputs a result of processing within the signal processing means, wherein the illumination optical system irradiates divided pulse laser, which are obtained by dividing the one pulse of the pulse laser into plural numbers thereof, respectively, upon separate positions on the sample.

Also, for dissolving such problems as mentioned above, according to the present invention, there is also provided a defect inspection method, comprising the steps of: mounting a sample on a rotatable table to rotate; irradiating a pulse laser emitted from a laser light source upon the rotating sample; detecting a reflected light from the sample, upon which the pulse laser is irradiated; detecting the reflected light from the sample detected; and detecting a defect on the sample through processing of a signal obtained through the detection, wherein irradiation of the pulse laser emitted from the laser light source upon the rotating sample is conducted by dividing the one pulse emitted from the laser light source into plural numbers of pulses, and irradiating each of the divided pulse lasers upon each of separate positions on the sample, respectively.

According to the present invention, it is possible to detect the fine defects, without giving the thermal damages upon the sample, while scanning the entire surface of the sample.

Those features and advantages of the invention will be apparent from the following more particular description of preferred embodiments of the invention, as illustrated in the accompanying drawings.

### BRIEF DESCRIPTION OF THE DRAWINGS

FIG. 1A is a block diagram for showing an entire brief configuration of a defect inspection apparatus, according to an embodiment of the present invention;

FIG. 1B is a block diagram for showing the structure of an attenuator;

FIG. 1C is a block diagram for showing the structure of a signal processor portion;

FIG. 2 is a block diagram of a detector portion for showing an arrangement of the detector portion and detecting direction, according to the embodiment of the present invention;

FIG. 3 is a block diagram for showing the structure of a pulse divider potion;

FIG. 4A is a plane view of a sample for showing an illumination pattern on a sample, according to the embodiment of the present invention;

FIG. 4B is a graph for showing changes of θ position, at which an illumination is made, together with time, when the illumination is made while shifting pulse-like beams divided in θ direction, according to the embodiment of the present invention;

FIG. 4C is a graph for showing changes of R position, at which an illumination is made, together with time, when the illumination is made while shifting the pulse-like beams divided in radial (R) direction, according to the embodiment of the present invention;

FIG. 5A is a block diagram for showing an entire brief configuration of a defect inspection apparatus, according to other embodiment of the present invention;

FIG. 5B is a block diagram for showing an entire brief configuration of a defect inspection apparatus, according to further other embodiment of the present invention;

FIG. 6 is a view for explaining calculation of a compensation coefficient for position, according to the embodiment of the present invention;

FIG. 7 is a view for explaining a relationship between an angle of a mirror and fluctuation of an input to a light flux enlargement portion, according to the embodiment of the present invention;

FIG. 8 is a block diagram for showing the structure of a detector portion, according to the embodiment of the present invention;

FIG. 9 is a block diagram for showing the structure of an analog processor portion, according to the embodiment of the present invention;

FIG. 10A is a block diagram for showing the structure of a digital processor portion for integrally processing pulses divided, according to the embodiment of the present invention;

FIG. 10B is a block diagram for showing the structure of a digital processor portion for independently processing the pulses divided, according to the embodiment of the present invention;

FIG. 11 is a block diagram for showing the structure of a digital processor portion for integrally processing the pulses divided, according to the embodiment of the present invention;

FIG. 12(a) is a plane view of the sample for showing a condition of a spiral inspection on the sample, FIG. 12(b) is a block diagram for showing a relationship between a memory portion and a calculator portion, and FIG. 12(c) is a picture of bright spots, which can be observed by a TV camera; and

FIG. 13 is a front view of a display screen for showing GUI thereon, for enabling a manual setup of an angle of a mirror, according to the embodiment of the present invention.

### DESCRIPTION OF THE PREFERRED EMBODIMENTS

Hereinafter, embodiments according to the present invention will be fully explained by referring to the drawings attached herewith.

### Embodiment 1

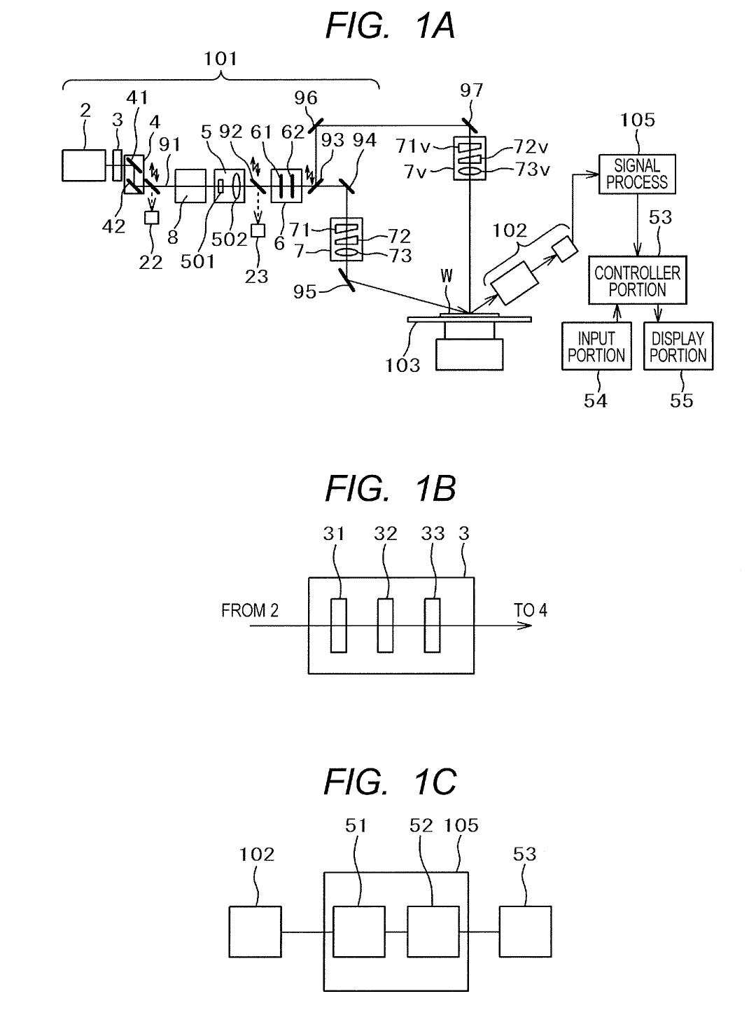

Explanation will be given on a first embodiment of the present invention, by referring to FIG. 1. This comprises an illumination portion 101, a detector portion 102, a stage 103 for mounting a sample W thereon, being able to rotate and move into a direction perpendicular to a center axis of the rotation, a signal processor portion 105, a controller portion 53, a display portion 54 and an input portion 55.

The illumination portion 101 comprises a laser light source 2, an attenuator 3, an emitting light adjustor portion 4 for exiting lights, a pulse divider portion 8, a light flux enlargement portion 5, a polarized light controller portion 6 and an illumination condense controller portion 7. The laser light source 2 is a pulse oscillation or a pseudo-continuous oscillation laser, and typically the light emission time thereof is equal to or less than 15 ps; i.e., the pulse-like light is outputted at an interval of every 10 ns. Also, from the laser light source 2 is irradiated the laser beam, which is collimated. In case of the laser light source, emitting the light therefrom, which is not collimated, a collimator lens is provided, separately, so as to collimate the illumination.

The laser light beam emitting from the laser light source 2 is adjusted to a desired beam intensity by the attenuator 3, and also adjusted to a desired beam position and a beam traveling direction by mirrors 41 and 42 of the emitting light adjustor portion 4, and further each of the pulse of the pulsed laser beam is divided by time into plural numbers of pulses, in the pulse divider portion 8. This light flux is enlarged by a concave lens 501 and a convex lens 502 of the light flux enlargement portion 5, while each of the pulses, which are divided in the pulse divider portion, is reduced in fluctuation of the direction of the flux thereof, and is adjusted into a desired polarization condition by a 1/2 wavelength plate 601 and a 1/4 wavelength plate 602 in the polarized light controller portion 6, and further adjusted into a desired intensity distribution in the illumination light condensing controller portion 7, thereby being incident upon, from an oblique direction with respect to the sample W, so as to illuminating an inspection target area or region (i.e., an oblique incident illumination).

In the pulse divider portion 8, being the feature according to the present invention, fluctuation in an angular direction of the optical axis of the pulse lights, each being divided by time, lowers down a light condensing performance at the illumination light condensing controller portion 7, then it is difficult to form a fine spot on the sample W. Then, the pulse divider portion makes such an adjustment that each of the divided pulses has a difference in angle, respectively. Typically, the beam spot is divided in a radius direction of the sample W, so as to make an illumination, or this may be divided in a rotation direction. Further, the beam spot may be divided but not separated, and so disposed that beam profiles are overlapped each other. The details of the divided beam profiles will be explained later.

The configuration of illumination area on the sample is made into a rectangular shape having a high aspect ratio, in general, so as to bring the damages to be minimum with respect to heat. For this reason, the illumination light condensing controller portion 7 illuminates by means of a light condenser lens 73, typically, after shaping up the illumination light flux by two sets of anamorphic prisms 71 and 72. Or, in the place of the light condenser lens 73 may be used a diffraction optical element.

Although a large number of reflection mirrors 91 to 97 are provided within an optical path of the illumination portion 101, an incident angle (i.e., an inclination angle with respect to a normal line direction on the sample surface) of the illumination light with respect to the sample surface is determined by a position and an angle of the reflection mirror 95 among of those. The incident angle of the illumination light is set to an angle, being suitable for detecting fine defects. The larger the incident angle of the illumination light, in other words, the smaller the elevation angle of the illumination (i.e., an angle defined by the sample surface and the optical axis of the illumination), the weaker the scattered light (being called, “haze”) from fine unevenness of the surface of the sample, therefore this is suitable for detecting the fine defects. For this reason, if the scattered light from the fine unevenness of the sample surface prevents the detection of the fine defects, the reflection mirror 95 is so adjusted that an incident angle of the illumination light comes to be equal to or greater than 75 degrees (or equal to or less than 15 degrees in the elevation angle).

On the other hand, in an oblique incident illumination, the smaller the illumination incident angle, the larger the absolute amount of the scattered light from the fine foreign matters, then if shortage of the amount of the scattered light from the defects prevents the detection of the fine defects, the incident angle of the illumination light is set to be equal to or greater than 60 degree and to be equal to or less than 75 degrees (equal to or greater than 15 degrees and equal to or less than 30 degrees in the elevation angle). Also, when conducting the oblique incident illumination, applying a P-polarized light as the polarized light of the illumination enables to increase the amount of the scattered light from the defects on the sample surface, comparing to other polarization light.

An illumination optical path is changed, by inserting the mirror 93 within the optical path of the illumination portion 101, through driving the mirror 93 by a driving means (not shown in the figure) of that mirror 93 (see the condition shown in FIG. 1A), and after changing the optical path by the mirrors 96 and 97, and passing through the illumination light condensing controller portion 7v (i.e., a vertical illumination), the illumination light is irradiated upon the surface of the sample W in the vertical direction. In this instance, distribution of the illumination intensity on the surface of the sample is also controlled by the illumination light condensing controller portion 7v, in the similar manner to that of the oblique incident illumination. For detecting the scattered light from concave-like defects (e.g., abrasive scratches and/or crystal defects in a crystalline material) on the sample surface, the vertical illumination, which enters the light upon the sample surface substantially at the right angles, is suitable.

As the laser light source 2 is applied one, for the purpose of detecting the fine defects in the vicinity of the sample surface, oscillating a short wavelength (i.e., being equal to or lower than 355 nm in the wavelength), such as, an ultraviolet or a vacuum ultraviolet laser beam, which hardly penetrates into an inside of the sample, and further having a high output, such as, being equal to or greater than 2 W in the output thereof. A beam diameter of an emitting beam is around 1 mm. For detecting defects in an inside of the sample is applied a laser enable to oscillate a visible or an infrared laser beam, which can easily penetrate is into the inside of the sample.

As is shown in FIG. 1B, the attenuator 3 comprises a first polarizing plate 31, a 1/2 wavelength plate 32, which is able to rotate around the optical axis of the illumination light, and a second polarizing plate 33. The light incident upon the attenuator 3 is converted into a linear polarized light by the first polarizing plate 31, and is rotated in the polarization direction thereof into an arbitrary direction depending on a delay-phase axis azimuth angle of the 1/2 wavelength plate 32, and then it passes through the second polarizing plate 33. The light intensity can be reduced down to an arbitrary ratio by controlling the azimuth angle of the 1/2 wavelength plate 32. In case where the light incident upon the attenuator 3 is sufficiently high in a degree of polarization thereof, the first polarizing plate 31 is not always necessary. As the attenuator 3 is applied one, which is corrected in advance in a relationship between an input signal and a light reduction ratio thereof. As that attenuator 3 can be applied a ND filter having a distribution of gradation density.

The emitting light adjustor portion 4 comprises plural pieces of reflection mirrors. Herein, explanation will be given on an example where it is constructed with two pieces of reflection mirrors 41 and 42. Herein, while defining a 3-dimensional rectangular coordinate system (i.e., an XYZ coordinate system), provisionally, it is assumed that the incident light upon the reflection mirror 41 is deflected in +X direction. The first reflection mirror 41 is provided in such a manner that it deflects the incident light into +Y direction (incidence/reflection within XY plane), while the second reflection mirror 42 is provided in such a manner that it deflects the light reflecting on the first reflection mirror 41 into +Z direction. Each of the reflection mirrors 41 and 42 is adjustable in a translation movement and a tilt angle, and with this, a position and a traveling direction (i.e., an angle) of the light emitting from the emitting light adjustor portion 4 is adjusted. As was mentioned above, with arranging the incidence/reflection plane (e.g., the XY plane) of the first reflection mirror 41 and the incidence/reflection plane (e.g., the YZ plane) of the second reflection mirror 42 in such a manner that they cross at right angles, it is possible to conduct the adjustments on the position and the angle of the light emitting from the emitting light adjustor portion 4 (traveling into the Z direction) within an XZ plane, as well as, the adjustments on the position and the angle thereof within a YZ plane, independently.

The condition of the light emitted from the emitting light adjustor portion 4 is reflected by the mirror 91, which can move forward and backward, with respect to the optical path of the emitted light, through driving by the driving means not shown in the figure, to be observed on a monitor 22.

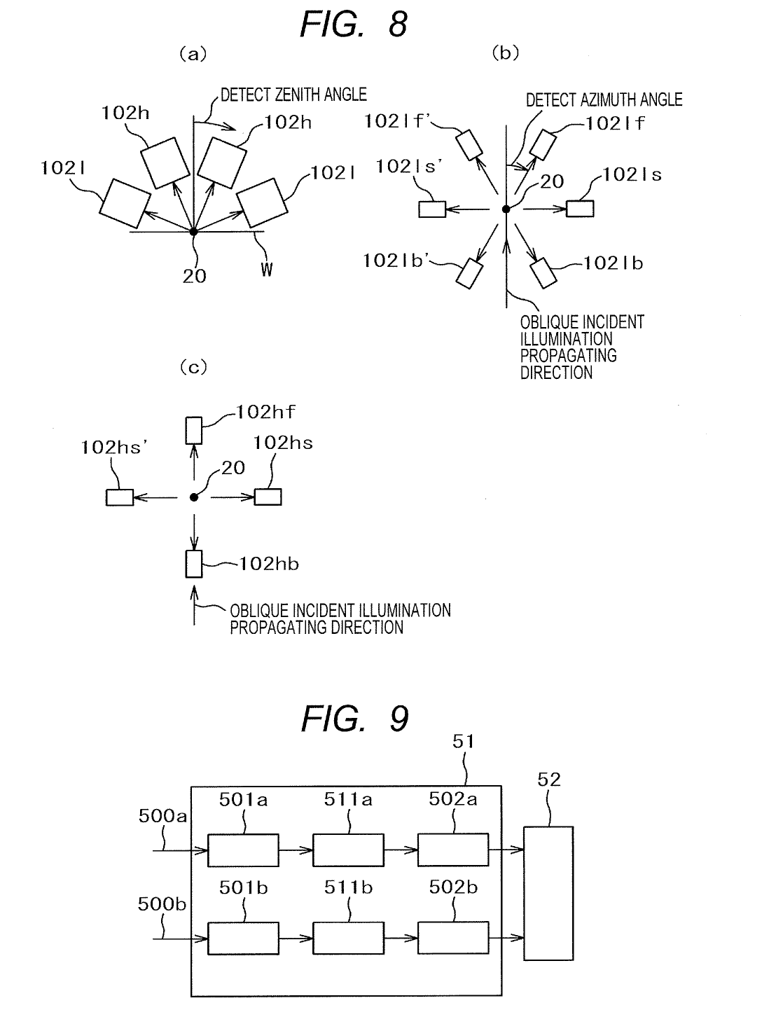

The detector portion 102 has plural detectors which are disposed in plural directions, so that they can detect the scattered lights in plural directions, which are generated from an illumination area or region 20. An arrangement of the detector portion 102 with respect to the sample W and the illumination region 20 will be explained by referring to FIG. 8.

In FIG. 8 (a) is shown a side plane view of arrangement of the detector portion 102. The illumination region 20 has a configuration, elongating in the direction perpendicular to a paper surface of FIG. 8 (a). An angle in the direction of detection (i.e., direction to a center of a detection opening: the direction of each arrow in FIG. 8(a)), which is defined by the detector portion 102, with respect to the direction of the normal line of the sample W, is called a detect zenith angle. The detector portion 102 is constructed with a high-angle detect portion 102h having the detect zenith angle being equal to or less than 45 degrees, and a low-angle detect portion 102l having the detect zenith angle being equal to or greater than 45 degrees.

Each of the high-angle detect portion 102h and the low-angle detect portion 102 is made up with plural numbers of detect portions, so that it can cover the scattered lights scattering in a large number of directions within each detect zenith angle.

FIG. 8 (b) shows a plane view of the arrangement of the low-angel detect portion 102l. The illumination region 20 has the configuration, elongating along with the traveling direction of the oblique illumination as is shown by an arrow. Within the plane in parallel with the surface of the sample W, an angle, which is defined by a traveling direction of the illumination light and a detect direction of the oblique illumination system, is called a detect azimuth direction. The low-angle detect portion 102l comprises a low-angle front detect potion 102lf, a low-angle side detect portion 102ls and a low-angle back detect portion 102lb, and further a low-angle front detect potion 102lf′, a low-angle side detect portion 102ls′ and a low-angle back detect portion 102lb′, which are disposed at the positions symmetric to those, with respect to an incident surface of illumination. The low-angle front detect portions 102lf and 102lf′ are provided at the detect azimuth angle being equal to or greater than 0 degree and equal to or less than 60 degrees, the low-angle side detect portions 1021s and 102ls′ at the detect azimuth angle being equal to or greater than 60 degrees and equal to or less than 120 degrees, and the low-angle back detect portions 102lb and 102lb′ at the detect azimuth angle being equal to or greater than 120 degrees and equal to or less than 180 degrees, respectively.

FIG. 8 (c) shows a plane view of the arrangement of the high-angle detect portion 102h. The high-angle detect portion 102h comprises a high-angle front detect potion 102hf, a high-angle side detect portion 102hs and a high-angle back detect portion 102hb, and a high-angle back detect portion 102hb′ that is located at the position symmetric to the high-angle side detect portion 102s with respect to the incident surface of illumination. The high-angle front detect portions 102lf is provided at the detect azimuth angle being equal to or greater than 0 degree and equal to or less than 45 degrees, the high-angle side detect portions 102hs at the detect azimuth angle being equal to or greater than 45 degrees and equal to or less than 135 degrees, and the high-angle back detect portions 102hb at the detect azimuth angle being equal to or greater than 135 degrees and equal to or less than 180 degrees, respectively.

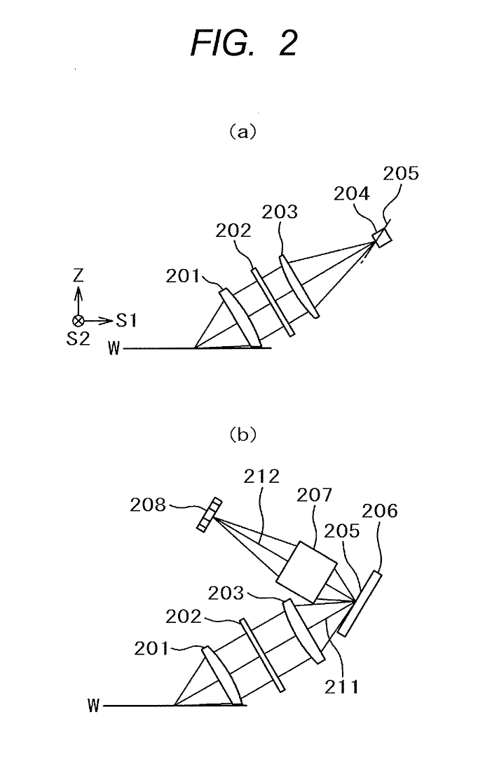

Detailed structures of the detector portion 102 are shown in FIG. 2. FIG. 2 (a) shows an embodiment in case of applying a point sensor 204 therein, while FIG. 2(b) an embodiment in case of applying a line sensor 208, in the place thereof.

The scattered lights generating from the illumination region 20 (having the configuration elongating in the direction perpendicular to the paper surface) are condensed by an objective lens 201, and after passing through a polarization filter 202, they are guided onto a light receiving surface of a sensor 204 by an image forming lens 203, thereby to be detected. The reference numeral 204 shown in FIG. 2 (a) depicts the pint sensor, while 208 shown in FIG. 2 (b) a sensor having plural numbers of pixels (i.e., a multi-pixel sensor). For the purpose of detecting the scattered lights, a detection NA of the objection lens 201 is equal to or greater than 0.3.

In case of the low-angle detector portion 102l, a lower end of the objective lens 201 is cut out, so that it does not interfere with the sample surface W, depending on the necessity thereof. The polarization filter 202 is made of a polarizing plate or a polarized light beam splitter, and is provided so that it cuts out a linear polarization component in an arbitrary direction. As the polarizing plate, a wire-grid polarizing plate, etc., having a transmittance equal to or greater than 80% is applied. When cutting out an arbitrary polarization component, including an oval polarization therein, the polarization filter 202 may be constructed with combination of a wavelength plate and a polarizing plate (not shown in the figure).

For the point sensor 204 and the multi-pixel sensor 208, it is preferable to have a high quantum efficiency (i.e., equal to or greater than 30%), for detecting with high sensitivity, and to be one that is able to electrically amplify electrons after photoelectron conversion. And for performing in high-speed, it is also preferable that a plural numbers thereof can read out signals thereof in parallel with, or for maintaining a detection dynamic range, and that the detection sensitivity thereof (i.e., a gain of electrical amplification) can be changed, easily, in a short time-period by an electric means, etc.

As the point sensor 204 is applied a photomultiplier tube or an avalanche photo-diode, and as the multi-pixel sensor 208, which is constructed with plural numbers of pixel sensors, is applied a multi-anode photomultiplier tube, or an avalanche photo-diode array, or a linear EMCCD (Electron Multiplexing CCD) enabling parallel read-out of signals, a linear EBCCD (Electron Bombardment CCD) enabling parallel read-out of signals.

By means of the objective lens 201 and the image forming lens 203, an image of the surface of the sample (i.e., the sample surface) is formed on a conjugated plane of the sample surface. This forms the image, inclining to the sample surface. For this reason, although an object lying at the position where image height is large, not form an image thereof on the light-receiving surface of the multi-pixel sensor 208, but becomes blurring, in a scanning direction S1; however, since the size of the illumination region 20 is short in that scanning direction S1, the object lying at the position where image height is large does affect no ill influence upon the detection.

FIG. 2(b) shows the structure in case where the multi-pixel sensor 208 is applied as the sensor. After being condensed by the objective lens 201 and passing through the polarization filter 202, the scattered light generated from the illumination region 20 forms an image (so-called, an intermediate image) of the sample surface on a diffraction grating 206, which is provided on a plane 205 conjugated with the sample surface, by means of the image forming lens 203. The image of the sample surface, which is formed on the diffraction grating 206, is projected on the light receiving surface of the multi-pixel sensor 208 through an image forming system 207, to be detected.

The multi-pixel sensor 208 is disposed within the plane conjugated with the sample surface, so that the direction of disposing the pixels is coincident with a longitudinal direction of the image of the illumination region 20 (i.e., the direction perpendicular to the drawing), fitting to the configuration of the illumination region 20 elongating in one direction.

As the diffraction grating 206 is applied one, being formed with such a diffraction grating configuration that an N-th diffraction light generated from the light incident on the grating, traveled along with an optical axis 211 of the light, which is guided by the image forming lens 203 and forms the intermediate image, is diffracted in the direction of the normal line 206 to the surface of the diffraction grating 206, i.e., for the purpose of diffracting the light, being guided by the image forming lens 203 to form the intermediate image, into the direction of the normal line on the surface of the diffraction grating 206. For the purpose of increasing diffraction efficiency, a brazed grating is used. However, regarding the low-angle and the high-angle side detect portions 102ls, 102ls′ and 102hs, 102hs′ (see FIGS. 8 (b) and (c)), each having detection azimuth angle of 90 degrees, since the image height can be suppressed to be small, the multi-pixel sensor of 208 may be disposed at the position of the diffraction grating 206, while omitting the diffraction grating 206 and the image forming system therefrom. With such construction as mentioned above, i.e., providing the multi-pixel sensor 208 on the conjugated surface with the sample surface, it is possible to ensure an effective field of view in a wide range with suppressing the condition of out of focus, even in the S1 direction on the sample surface, and also to detect the scattered lights with a less amount of loss of lights.

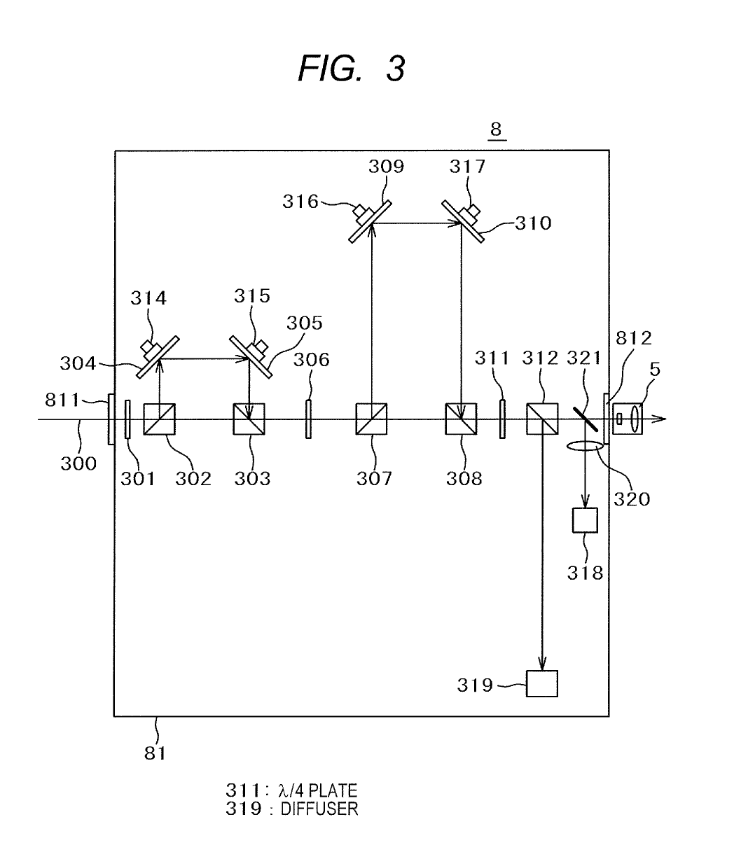

The structure and the functions of the pulse divider portion 8 will be explained by referring to FIG. 3. It is preferable that the pulse divider portion 8 is placed in a container 81 of a hermetic structure so as to be filled up with an inactive gas therein. A reference numeral 300 depicts the illumination light emitted from the emitting light adjustor portion 4, and this is a collimated light. The illumination light 300 entering from an incident window portion 811 into an inside of the hermetic structure container 81 comes to a circularly polarized light when passing through the 1/4 wavelength plate 301, and the light is divided into two by a polarized light beam splitter 302, i.e., a polarization component passing through the polarized light beam splitter 302 and a polarization component reflected on the polarized light beam splitter 302. An optical path difference is generated between the lights, i.e., the one of the lights divided, which is reflected upon the polarized light beam splitter 302 and enters onto the polarized light beam splitter 303 through the mirrors 304 and 305, to be reflected into the direction of the 1/4 wavelength plate 306, and the other of the lights divided, which enters onto a polarized light beam splitter 303, directly, after passing through the polarized light beam splitter 302, and passes through the polarized light beam splitter 303, thereby turning into the direction of the 1/4 wavelength plate 306, and the pulse is divided.

The 1/4 wavelength plate 306 turns the polarized light traveling along the respective optical path back to the circularly polarized light, again. This circularly polarized light, being incident upon a polarized light beam splitter 307, is divided into two optical paths of the polarized light component passing through the polarized light beam splitter 307 and a polarized light component reflected thereon. A difference of the optical path is generated between the two lights; i.e., the one of the lights divided, which is reflected upon the polarized light beam splitter 307 and enters into a polarized light beam splitter 308 through the mirrors 309 and 310, to be reflected into the direction of the 1/4 wavelength plate 311, and the other of the lights divided, which enters into the polarized light beam splitter 308, directly, after passing through the polarized light beam splitter 307, and passes through the polarized light beam splitter 308, and herein the pulse is further divided. Typically, the optical path difference from the light passing through the polarized light beam splitter 302, which is generated due to passing through the mirrors 304 and 305, is determined to be as 2 times large as the optical path difference from the light passing through the polarized light beam splitter 307, which is generated due to passing through the mirrors 309 and 310.

The polarized light passing through or reflecting upon the polarized light beam splitter 308 enters into a 1/4 wavelength plate 311 to be emitted from, in the form of the circularly polarized light. The light converted into the circularly polarized light by this 1/4 wavelength plate 311 enters into a polarized light beam splitter 312, wherein a P-polarized light component thereof passes therethrough, while a S-polarized light component thereof is reflected therefrom and enters into a diffuser 319, to be removed from the light emitted from the pulse divider 8.

The lights emitted from the polarized light beam splitter 303 are so set that a predetermined constant angle difference can be defined between the light passing through the mirrors 304 and 305, and the light entering therein, directly from the polarized light beam splitter 302. And also, in the similar manner, the lights emitted from the polarized light beam splitter 308 are so set that a predetermined constant angle difference can be defined between the light passing through the mirrors 309 and 310, and the light entering into the polarized light beam splitter 308, directly from the polarized light beam splitter 307. Typically, the angular difference between the lights emitted from the polarized light beam splitter 308 is determined to be 0.5 time (1/2) of the angular difference of the lights emitted from the polarized light beam splitter 303. In the illumination light condensing controller portion 7, the illumination is made in relation to the angular difference of the light when each pulse emits from the polarized light beam splitter 308. Reference numerals 314 to 317 depict position controlling mechanisms, to be applied for controlling angels of the mirrors 304, 305, 309 and 310, respectively, and they are made controllable from the controller portion 53.

A reference numeral 318 depicts a TV camera for observing an arraignment condition of the mirrors 304, 305, 309 and 310, and on this TV camera 318 can be observed the alignment of the mirrors 304, 305, 309 and 310, branching the optical path of the P-polarized light passing through the polarized light beam splitter 312 into the direction of the TV camera 318, with an insertion of a mirror 321, which is driven by a driving mechanism not shown in the figure, into the optical path.

When the observation of the alignment condition of the mirrors 304, 305, 309 and 310 by the TV camera 318 through the lens 320 is completed, the mirror 321 is driven by the driving mechanism not shown in the figure, to be evacuated from the optical path of the P-polarized light passed through the polarized light beam splitter 312, and the P-polarized light passes through an emitting window 812 to be emitted from the pulse divider potion 8, and then enters into the light flux enlargement portion 5.

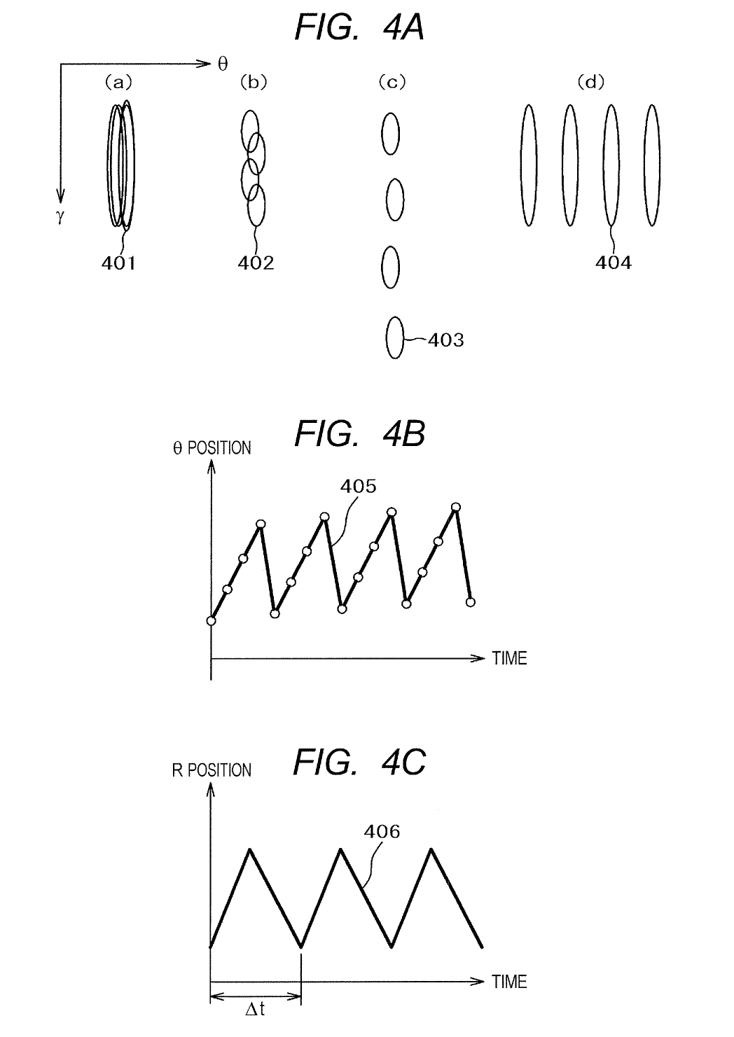

In FIG. 4A shows an example of the illumination, which is divided and illuminated. (a)-(d) in FIG. 4A are examples of being applied in beam spots, respectively, and are illumination patterns, being shifted minutely in positions thereof, into “r” direction (e.g., a radius direction) of the sample. The mirrors 304, 305, 309 and 310 are shifted in adjustment conditions thereof depending on time-sequential changes, and there are cases where the illumination positions are shifted into an unexpected θ direction. And in those instances, there is a problem that the beam spots are enlarged in the θ direction, as is shown in (a). For conducting the inspection with high sensitivity, it is necessary that the illumination should be stopped or narrowed in the θ direction, into which the sample rotates.

Shifting the positions, minutely, in the “r” direction, into which the sample rotates, as is shown by the beam spots 402 of (b), results into a stop or a diaphragm in the θ direction on the sample, even if the illumination positions are shifted in the θ direction of the sample, slightly, and therefore achieving the inspection with high sensitivity. Also, the position where the brightness is at the maximum thereof is enlarged, while foots in R direction are narrowed, then it is possible to increase an intensity of the illumination to be larger than that of the spot beams 401 of (a); i.e., achieving the high sensitivity. Since the pulse is divided time-sequentially, at an arbitrary time, only one spot is illuminated. This characteristic is important for obtaining the high sensitivity in the signal processor portion, which will be mentioned later.

Spot beams 403 of (c) are an embodiment of the illumination in case where the illumination is further shifted into the “r” direction. In this manner, in case shifting the position of the spots, largely, since heats can easily spread in the vicinity thereof on the sample, an increase of the average temperature is suppressed, and further it is possible to increase the intensity of the illumination. Also, as is shown by the beam spots 404 of (d), by shifting them into the θ direction, it is possible to suppress an instantaneous increase of temperature. Shifting the beam spots into the θ direction results to be disadvantageous for the averaged increase of temperature; however, in case of applying the image forming detector system shown in (b) of FIG. 2, since it is impossible to shift the positions, largely into the “r” direction, then the beams can be used, effectively.

The light flux enlargement portion 5 has two or more numbers of lens groups, and has a function of enlarging the diameter of a parallel light flux entering thereupon. In FIG. 1A is shown an example of a Galileo-type beam expander, which comprises combination of the concave lens 501 and the convex lens 502. The light flux enlargement portion 5 is installed on a translational stage having two or more numbers of axes thereof (not shown in the figure), and it is constructed to be adjustable in the position thereof, so that a center thereof comes to be coincident with a predetermined beam position. And, it also has a tilt angle adjusting function mechanism (not shown in the figure) for the entire of the light flux enlargement portion 5, so as to bring an optical axis of the light flux enlargement portion 5 to be coincident with an optical axis of the beam reaching to the polarized light controller portion 6 from the pulse divider portion 8. By adjusting the distance between the concave lens 501 and the convex lens 502, it is possible to control the magnification of the diameter of the light flux (i.e., a zoom mechanism).

The TV camera 318 is connected with the controller portion 53, and when a dot of light thereof is shifted from an expected one, an automatic adjustment is conducted with using the mirror position controlling mechanisms from 314 to 317 of the pulse divider portion 8. In this example, the distance between the beam spots is adjusted, automatically, with using the mirror position controlling mechanisms 316 and 317, and the distance between the beam spots is adjusted, automatically, with using the mirror position controlling mechanisms 314 and 315. While outputting the position of a center of gravity of the dot of light, within the video processing, the four pieces of mirrors 304, 305, 316 and 317 are changed in the angles thereof, with using the mirror position controlling mechanisms 314, 315, 316 and 317, and the mirrors are fixed at the positions where the position of the center of the gravity comes close to the expected position at the most.

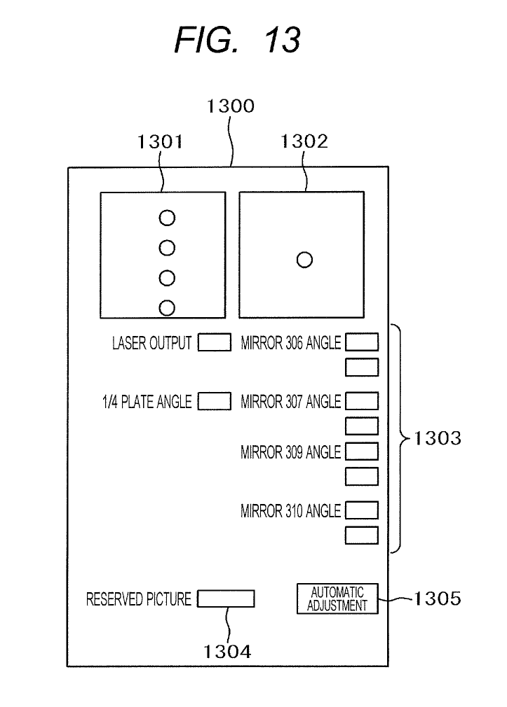

An example of a method for adjusting the mirrors 304 and 305 with applying the TV camera 18 therein will be shown in FIG. 7. In case where inclining angles are shifted from that of the designed positions thereof, by only Δθ1 and Δθ2, respectively, on the mirrors 304 and 305, an amount of shifting comes to 2 Δθ1×1, during when guiding the light from the mirror 304 to the mirror 305, to 2(Δθ1+Δθ2)y1, during when guiding the light from the mirror 304 to the beam splitter 302, and further to 2(Δθ1+Δθ2)×2, during when guiding the light from the beam splitter 302 to the TV camera 318, respectively, from the designed positions thereof, and by setting the parallel light to be condensed on the CCD of the TV camera, then this angle shifting is detected to be the position of the TV camera 318, and therefore it is possible to obtain the angle shift of the mirrors. FIG. 13 shows a GUI 1300 for use of adjustment therein. A reference numeral 1301 depicts a screen for revealing an angle difference of each optical path for the pulses divided, which is captured by the TV camera 318, and 1302 an image of the beam just after the beam expander, which is captured by a beam monitor 23 disposed on a rear stage of the light flux enlargement portion 5. For the image 1302 of the beam, it is preferable to be condensed or focused into one point. The beam monitor 23 captures the image of the beam, reflected by a mirror 92, which can move forward and backward by a driving means not shown in the figure with respect to the optical axis of the light emitted from the light flux enlargement portion 5.

A reference numeral 1303 shows an angle of each mirror, and by inputting a numerical value(s) on the GUI 1300, the angles of the mirrors 304, 305, 309 and 310 can be changed, while controlling the mirror position controlling mechanisms 314, 315, 316 and 317, through the controller portion 53. Digital images of 1301 and 1302 can be saved, when a button 1304 is clicked, so that an analysis can be made on differences of the sensitivity or/and chronological changes of the sensitivity, between/among apparatuses. When an automatic adjustment button 1305 is clicked, then the controller portion 53 stars controls of the mirror position controlling mechanisms 314, 315, 316 and 317, so as to change the angles of the mirrors 304, 305, 309 and 310; i.e., automatically adjusting those angles to be coincident with the designed values thereof at the most.

The magnifying power for enlargement of the beam diameter by the light flux enlargement portion 5 is from 10 times to 20 times, then a beam having the diameter of 1 mm emitted from the light source 2 is enlarged to have the diameter from 10 mm to 20 mm, approximately. In this instance, an inclination of the optical axis of the divided pulse, caused due to the fact that one piece of pulse is divided time-sequentially within the pulse divider portion 8, is reduced down to 1/10 to 1/20, inversely. For example, in case that the fluctuation in the inclination of the optical axis for each of the divided pulses, which is emitted from the light flux enlargement portion 5, is about 100 μrad, the fluctuation in each pulsed light, which is emitted from the light flux enlargement portion 5 and divided, comes to 5 to 10 μrad.

The polarized light controller portion 6 is constructed to comprise a 1/2 wavelength plate 61 and a 1/4 wavelength plate 62, and controls the polarization condition of the illumination light into an arbitrary polarization condition.

The signal processor portion 105 comprises, as shown in FIG. 1C, an analog processor portion 51 and a digital processor portion 52. Explanation will be given about the analog processor portion 51 by referring to FIG. 9. Herein, for the purpose of simplification, among plural numbers of the detector portions 102, that corresponding to 1021s in FIG. 8 is assumed to be a detector portion 102a, while that corresponding to 102hs in FIG. 8 is assumed to be a detector portion 102b, and then explanation will be given on the structure of the analog processor portion 51 when comprising those two systems therein. Signal currents 500a and 500b outputted from the detectors (see 102ls and 102hs in FIG. 8), which are provided in each of the detector portions, respectively, are converted into voltages and amplified by pre-amp portions 501a and 501b, respectively. Those analog signals amplified, further after being removed from the high-frequency components generating aliasing, by means of low-pass filters 511a and 511b, are converted into digital signals within analog-digital converter potions (A/D converter portions) 502a and 502b, each having a sampling rate higher than a cutoff frequency of the low-pass filters 511a and 511b, and are outputted therefrom.

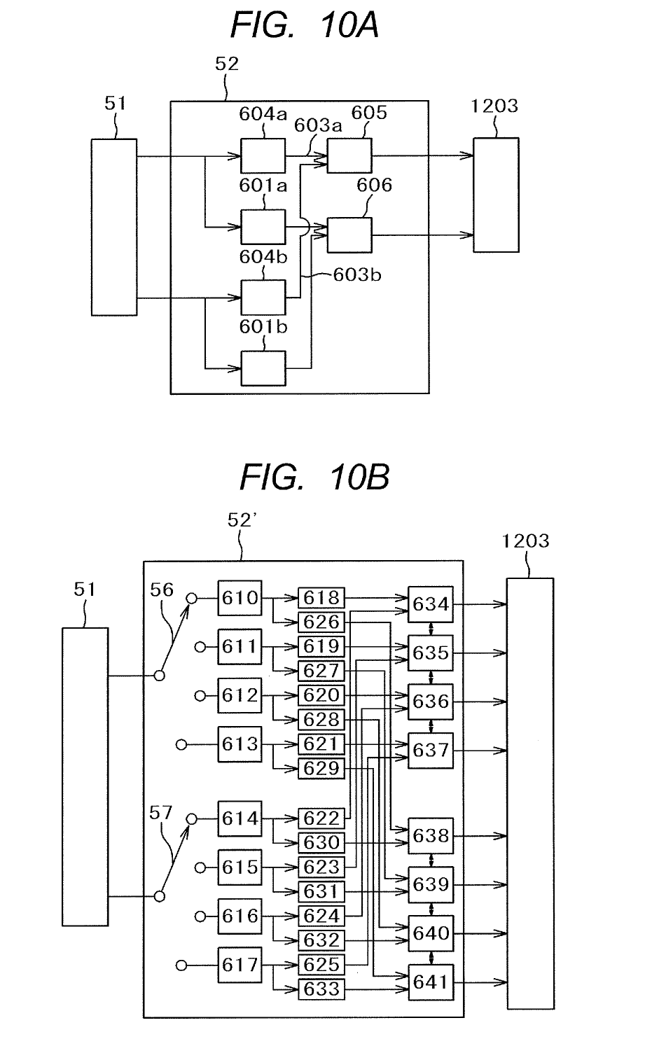

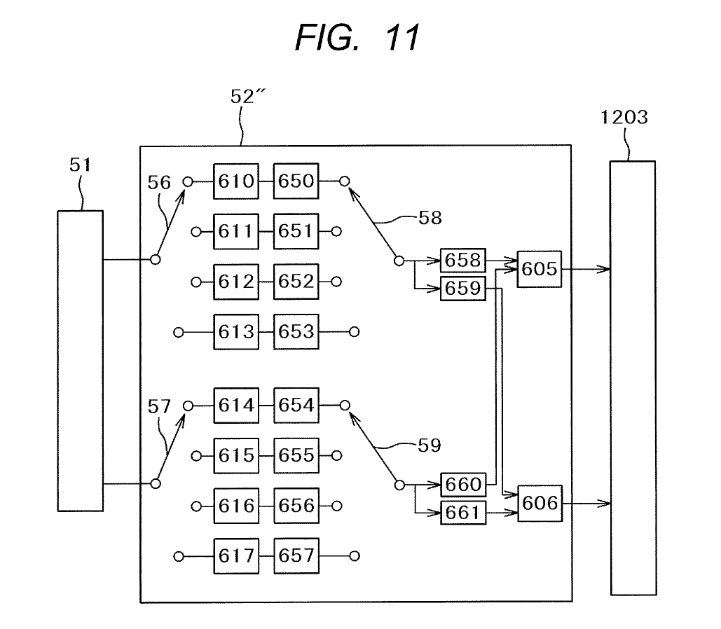

Next, explanation will be given about the digital processor portion 52, which builds up the signal processor portion 105, by referring to FIGS. 10A and 10B. The present embodiment is characterized in that the illumination, which is made by the pulses divided in the pulse divider portion 8, are divided to be processed. Herein, explanation will be given on the case where the pulse is divided into four by the pulse divider portion shown in FIG. 3. FIG. 10A shows the structure of the digital processor portion 52, corresponding to the method for processing the divided pulses by integrating, while FIG. 10B shows the structure of a digital processor portion 52′ corresponding to a method for processing the divided pulses, independently.

First of all, explanation will be given on the processes within the digital processor portion 52 shown in FIG. 10A. Each of the output signals from the analog processor portion 51 is processed in the digital processor portion 52 to extract defect signals 603a and 603b respectively by each of high-pass filters 604a and 604b and is inputted into a defect primary determining portion 605. Since the defect is scanned in the S1 direction by an illumination field 20, a wave shape of the defect signal comes to that scaling up/down a profile of distribution of luminous intensity in the S1 direction of the illumination field 20 (see FIG. 8). Accordingly, by letting frequency bands, including the defect signal waveforms therein, to pass through, with using the high-pass filters 604a and 604b, respectively, while cutting off frequency bands and a DC component, including a relatively large part of noises therein, the defect signals 603a and 603b are improved in S/N thereof. As each one of the high-pass filters 604a and 604b is applied a high-pass filter which is designed to have a specific cutoff frequency and to shut off the components having the frequencies lower than that frequency, or a band-pass filter, or a filter for forming a similar configuration to the waveform of the defect signal, upon which the configuration of the illumination region 20 is reflected.

The defect determining portion 605 conducts a threshold value process on the input signals including defect waveforms therein, which is outputted from each of the high-pass filters 604a and 604b, and thereby determining presence/absence of the detect. Thus, since the defect signals are inputted into the defect determining portion 605, upon basis of detection signals from plural numbers of the detection optical systems, and by conducting the threshold value process upon a sum or a weighted average of plural numbers of the defect signals, or by selecting OR and/or AND on the same coordinate system, determined on the surface of a waver in relation to a group of defects, which are extracted by the threshold value process, for plural numbers of the defect signals, the defect determining portion 605 is able to conduct the defect inspection with high sensitivity comparing to the defect detection made upon basis of a single detect signal.

Further, the defect determining portion 605 provides defect coordinates for indicating the defect position within the wafer and an estimation value of defect size, which are calculated upon basis of that defect waveform and a sensitivity information signal, to the controller portion 53 as detect information, in relation to a place where the defect is determined to be present therein, thereby to output it to the display portion 54 and so on. The defect coordinates are calculated upon basis of the center of gravity of the defect configuration. The defect size is calculated on the basis of an integrated value of the defect configuration or the maximum value thereof.

Each of output signals from the analog processor portion 51 is inputted into each of the low-pass filters 601a and 601b, respectively, in addition to the high-pass filters 604a and 604b which are components of the digital processor portion 52. From each of the low-pass filters 601a and 601b, low frequencies and the DC component are outputted , corresponding to an amount of the scattered light (i.e., the haze) from a fine roughness within the illumination region 20 on the wafer. In this manner, the output from each of the low-pass filters 601a and 601b is inputted into a haze processor portion 606 to be processed of haze information thereof. That is, the haze processor portion 606 outputs a signal corresponding to magnitude of the haze in each place on the wafer, judging from an amplitude of the input signal, which is obtained from each of the low-pass filters 601a and 601b, respectively, as a haze signal. Also, since an angular distribution of the amount of scattered light from the roughness changes depending on distribution of spatial frequency of the fine roughness, then as is shown in FIG. 8, the haze signals from each detector, among from plural numbers of detector potions 102, being provided in the azimuths and the angles differing from each other, are inputted into the haze processor portion 606, and therefore it is possible to obtain the information relating to the distribution of the space frequency of the fine roughness, from a ratio of intensity thereof, etc., from the haze processor portion 606.

Next, explanation will be made on the processes in the digital processor portion 52′ shown in FIG. 10B.

In the embodiment shown in FIG. 10B, it is possible to achieve further high sensitivity, by dividing the signal detected under the illumination of the pulse having the frequency higher than that of an oscillation pulse of the laser light source 2, which is outputted from the pulse divider portion 8, thereby to be detected independently. Herein, the pulse generated in the pulse divider portion 8 is called a sub-pulse. In general, noise components are shot noises of the sensor, which are generated upon detection of the surface roughness of the sample by the sensor. Since each sub-pulses illuminates the separate one of positions on the sample, the defect signal cannot be detected in all of the sub-pulses. Therefore, by detecting the defect in the sub-pulses, in a time-division manner, it is possible to detect the defect under the condition of reducing the ratio of the noise components with respect to the defect signal.

Reference numerals 56 and 57 depict multiplexers. Because of change of the position illuminated by each pulse illumination, a buffer for storing digital data is switched, so that the process can be made for each of the same positions on the wafer. For example, in case where the oscillating frequency of the laser 2 is 80 MHz and divided to be equal in the distance therebetween within the pulse divider portion 8, then the process is executed while switching the buffer at 320 MHz, being four times larger than the oscillating frequency of the laser 2. Reference numerals 610 to 613 depict buffers, and they are the buffers corresponding to the pulses to be illuminated through different optical paths within the pulse divider portion, in the detector 102a, while 614 to 617 depict similar buffers corresponding to the detector 102b. The detection signals accumulated in the buffers 610 to 617 are transmitted to defect determination portions 634 to 637 through the high-pass filters 618 to 625, respectively. Herein, in the defect determining portion 634, outputs from the high-pass filters 618 and 622 are added, i.e., the outputs, which are obtained under the same pulse from the separate detectors are integrated so as to execute the defect determination.

Internal processes in the defect determining portions 634 to 637 are the same with those in the defect determining portion 605 explained in FIG. 10A. The defect determination, similar to that in the defect determining portion 634, is conducted in the defect determining portions 635 to 637. Reference numerals 638 to 641 depict haze processor portions, in each of which the process similar to that in the haze processor portion 606 explained in FIG. 10A is executed. Also, the haze processor portion makes determination, in the similar manner to that in the defect determining portion, with integrating results obtained at the same timing, each, which are detected by the separate detectors. In case where the illumination is made while shifting the pulses divided in the θ direction, as shown in (d) of FIG. 4A, since the illumination position is determined depending on the sum of both the movement of the beam in the θ direction and the movement of the sample itself, the beam results to scan the same place by plural numbers of times in the θ direction. Time-sequential change of θ position, at which the illumination is made, is shown by 405 in FIG. 4B. In the figure, a small round mark indicates the position, at which the beam illumination is made.

The structure of a digital processor portion 52″ in this instance is shown in FIG. 11. In FIG. 11, the constituent elements attached by the reference numerals same to those in FIG. 10B are already explained by referring to FIG. 10B, and therefore the explanation thereof will be omitted herein. Reference numerals 650 to 657 depict FIFOs. Each FIFO holds data of time-period from when the sample rotates in the θ direction up to when the sample moves to an illumination place of next pulse. As a result of this, the data, being transferred to the high-pass filters 658 and 660 and the low-pass filters 659 and 661 through the multiplexers 58 and 59, come to be the data from the detector, scanning the sample continuously. However, if it is so designed that the data exist, which are outputted from the separate FIFOs, and which are at the same position before the filtering processes of the high-pass filters 658 to 661, it is preferable to execute an addition process before the filtering process.

### Embodiment 2

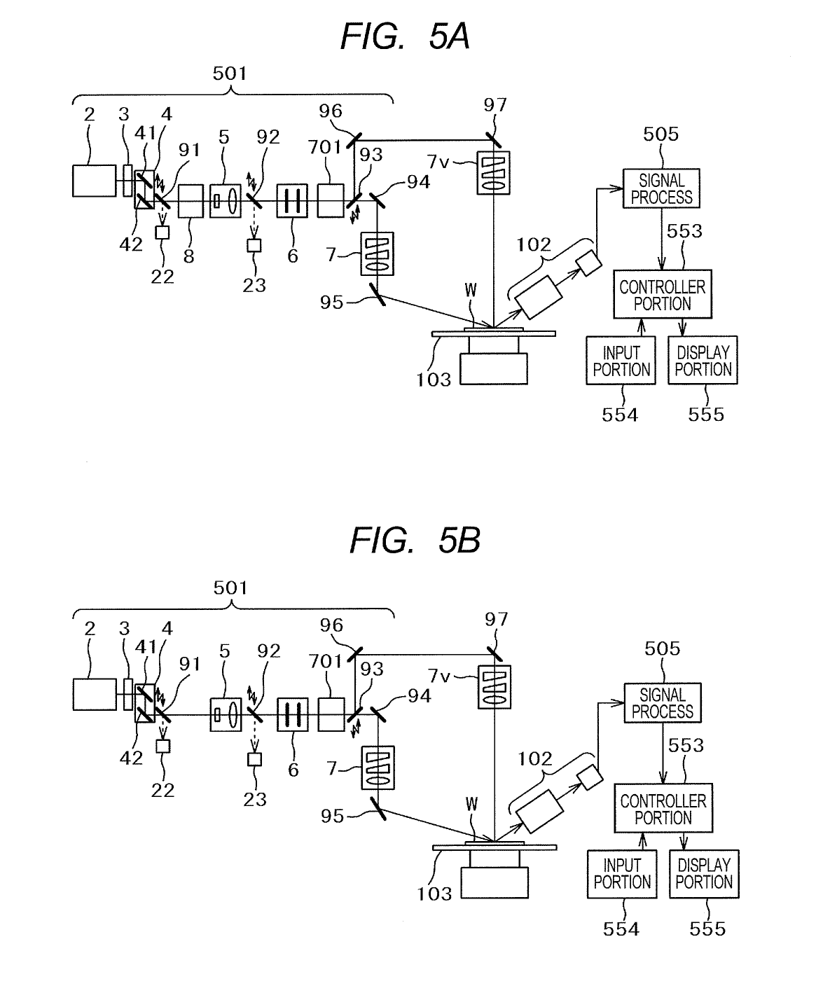

In the embodiment 1, it is described that executing the pulse division as a response to the instantaneous increase of temperature, and also on the method of conducting minute positional shifting on this divided pulse in the “R” direction in advance. However, since the oscillation frequency of the laser is extremely high comparing to the time necessary for the illumination area on the sample to move to the next one, there can occurs a phenomenon that the pulse is irradiated upon the same place on the sample by a large number of times, and it would cause a case that the increasing in temperature at the laser irradiated area on the sample cannot be fully suppressed down. Then, according to the present embodiment, with moving an irradiation position on the sample by a deflector at the same time of dividing the pulse, the thermal damages on the sample can be suppressed down, further more. The structure of the defect inspection apparatus according to the present embodiment is shown in FIG. 5A. Those attached with the reference numerals same to the constituent elements, which are explained in FIG. 1A, have the same structures and perform the same functions thereof, respectively.

Although what is shown in FIG. 5A is almost same to the structure shown in FIG. 1 explained in the embodiment 1, but it differs from that, in particular, in an aspect that a deflector 701 is disposed in front of the illumination condense controller portion 7 of the illumination portion 501. The parts attached with the reference numerals same to those of the constituent elements shown in FIG. 1 are same in the structure, and therefore the explanations thereof are omitted. As the deflector 701 is applied one, which can alter the angle at high speed, such as, an AO deflector or a DMD (Digital Micro-mirror Device), etc. When a condensed illumination is applied at a constant position on the rotating sample, a moving velocity at the illuminated portion on the sample is determined by the product r·sθ between the distance r from the center of the sample and a rotation speed se, and if r=75 mm, and the rotation speed is 400 rpm, for example, then the time necessary for the illumination beam to pass through a typical width 10 μmin the θ direction takes about 640 ns. The frequency of the pulse when the pulse is irradiated on the sample after being divided is about 320 MHz, this means that 200 times of pulse-like illumination is irradiated during the irradiation area on the sample passes through 10 μm.

Then, the reflected or scattered light from the sample is detected, while moving the illumination position by the deflector 701, the intensity of illumination can be reduced per a unit area thereof. A waveform 406 shown in FIG. 4C shows time-sequential change of the r position when the beam 402 of (b) in FIG. 4A is deflected into the “r” direction. For suppressing the increase of temperature due to irradiation of a large number of pulses at one place down to 1/4, for example, so as to illuminate in a pattern of the beam 402, it is enough to deflect the beam in a region, as about four times large as a total sum of the illumination regions of four pieces of pulses, and in case of the pattern of the beam 403 of (c) in FIG. 4A, it is enough to move within the region, as around four times large as that of the illumination by one pulse. Also, in the placed of the “r” direction, it may be moved in the θ direction.

Since it is preferable that the detection is made by around two times or more than that, for line width in the θ direction of the illumination, then it is preferable to set At described in FIG. 4C to be 320 ns or less than that. Thus, it is preferable that a repetition frequency of the deflector 701 be 3 MHz or greater than that. The signal processor portion 105 in this instance can be deal with, by increasing a number of paralleling of the structure of the digital processor portion 52′ shown in FIG. 10B or the digital processor portion 52″ shown in FIG. 11. In this case, in addition to the buffers 610 to 617 provided in FIG. 10B, further buffers are provided, newly, responding to the changes of positions due to the deflector, other than the number of division of the pulse, and thereby enabling to execute the defect determining process for each position, respectively.

Also, it is the same in the case shown in FIG. 11. In order to scan a region of approximately four times lager comparing to the case where no deflector 701 is provided, the buffers are provided by the number of pieces, as four times large, approximately, as that of the structure shown in FIG. 10B, i.e., about 16 pieces, so that the multiplexers 54 and 55 can make controls of storing sensor data obtained at the same r position into the same buffer.

In this example, mentioning is made on the example of scanning the illumination on the sample 100 by means of the deflector 701 in the “r” direction; however, also, in case of scanning in the θ direction, it is possible to determine the defect by the processor portion having the structure similar to that shown in FIG. 11. Also, the number of the buffers can be deal with, by increasing the number thereof, but without losing the generality thereof.

Also, in case of applying the multi-pixel sensor as shown by 208, as the sensor, it can be deal with the structure, aligning the circuits shown in FIGS. 10A, 103 and 11, in parallel, by the number of the pixels of the multi-pixel sensor.

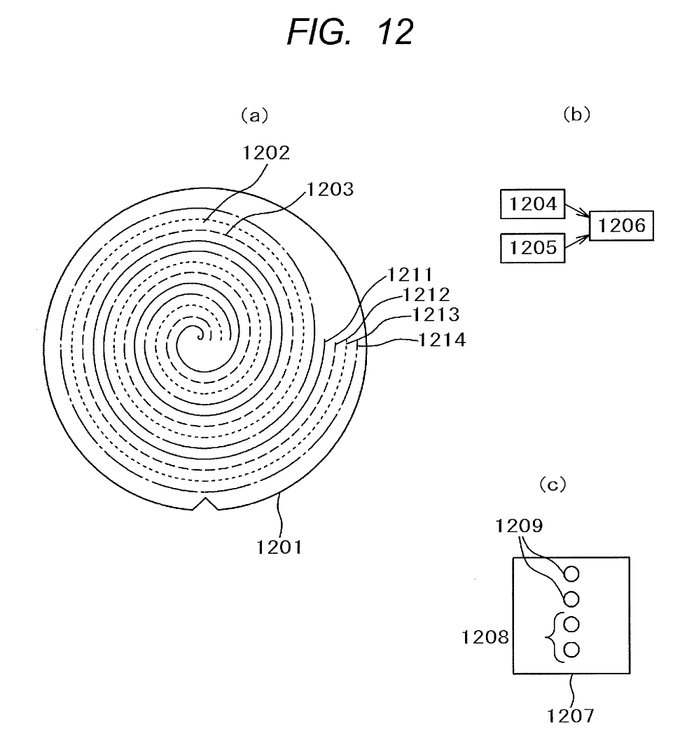

The defect determining portions 634 to 637, which are explained in FIG. 10B, are also able to conduct an interpolation calculation of data neighboring with in the “R” direction, for the purpose of executing the determination with further high accuracy thereof. Explanation will be made by referring to FIG. 12. A reference numeral 102 of (a) depicts the sample. When the sample is illuminated by the light pattern, which is shown by the beam 403 in (c) of FIG. 4A, after the pulse division into four pulses within the illumination portion 501, and the light reflected from the illumination portion 501 is detected with time-division; then, this means that irradiation by the four laser beams on the four spiral area on the sample is conducted, and the defect determination is done for each one of lines 1211 to 1214. In this case, before executing the threshold value process for the defect, the data, which are detected at the positions 1202 and 1203, for example, neighboring with each other in the “r” direction, are inputted into the memory portions 1204 and 1205, which are provided in the defect determining portions 634 to 637 shown in FIG. 10B, as is shown in FIG. 12 (b), and the detection light from the defect, which is expected to exist at an arbitrary position between the two points, through the interpolation by using a calculator 1206, and the threshold value process is executed on the expected defect in the defect determining portions 634 to 637, and thereby determining presence/absence of the defect.

In case of executing this process, it is necessary to calculate the distance between the positions 1202 and 1203 on the sample 1201, correctly. However, if the mirrors 304, 305, 309 and 310 of the pulse divider portion 8 are shifted in the adjustment thereof, then a locus of each divided pulse is not equal to in the distance therebetween, and an interpolating process cannot be done, accurately. Upon adjustment of the mirrors 304, 305, 309 and 310 is carried out by the image acquired by the TV camera 318 and an automatic correction is executed. To condense the beam on the TV camera 318, it is necessary that a luminescence point appears at an equal distance therebetween on the TV camera 318, as is an image 1207 of (c) in FIG. 12C when the illumination is made by the pattern shown by the beam 403, which is shown by (c) in FIG. 4A.

The TV camera is connected with the controller portion 553, and if the luminescence point is shifted from the expected point, it is automatically adjusted with using the mirror position controlling mechanism of 314 to 317 of the pulse divider potion 8. In this example, a beam spot distance 1208 is automatically adjusted with using the mirror position controlling mechanisms 316 and 317, and a beam spot distance 1209 is adjusted with using the mirror position controlling mechanisms 314 and 315. While outputting the center of gravity of the luminescence point through image processing, angles of four pieces of the mirrors 304, 305, 309 and 310 are altered with using the mirror position controlling mechanisms 314, 315, 316 and 317, and then the mirrors are fixed at the position where the position of gravity of the luminescence point comes close to the expected position at the most.

An example of the method for adjusting the mirrors 304 and 305 with using the TV camera 318 is shown in FIG. 7. In case where the inclination angels are shifted by only Δθ1 and Δθ2 from the designed positions on the mirrors 304 and 305, the light beam is shifted by the sum of the angles of those mirrors from the designed position, and if determining that parallel lights are condensed upon the CCD of the TV camera, since this angle shift of the mirrors can be detected as the position of the TV camera 18, then it is possible to obtain the shift of the mirror angles. In FIG. 13 is shown the GUI 1300 for use of adjustment therein. A reference numeral 1301 depicts a screen for actualizing the angle difference of each of the optical paths for divided pulses, which are imaged by the TV camera 318, and 1302 depicts an image of the beam just after a beam expander, which is imaged by the beam monitor 23 disposed in a rear stage of the light flux enlargement portion 5. Preferably, the image 1302 of the beam is condensed onto one point.

The beam monitor 23 captures an image of the beam reflected on the mirror 92, which can be put forward and backward by the driving means not shown in the figure, with respect to an optical axis of a light emitting from the light flux enlargement portion 5. A reference numeral 1303 depicts an angle of each mirror, and the angles of the mirrors 304, 305, 309 and 310 can be changed through controls on the mirror position controlling mechanisms 314, 315, 316 and 317 by the controller portion 53, when numerical values are inputted on the GUI 1300. This is so configured to save the digital images of the screens 1301 and 1302 when clicking a button 1304, and is also able to analyze the difference of the sensitivity between apparatuses and/or the time-sequential changes of the sensitivity. When clicking an automatic adjustment button 1305, the controller portion 53 starts controls of the mirror position controlling mechanisms 314, 315, 316 and 317, so as to change the angles of the mirrors 304, 305, 309 and 310, and thereby to automatically bring them to the angles coincident with the designed values thereof.

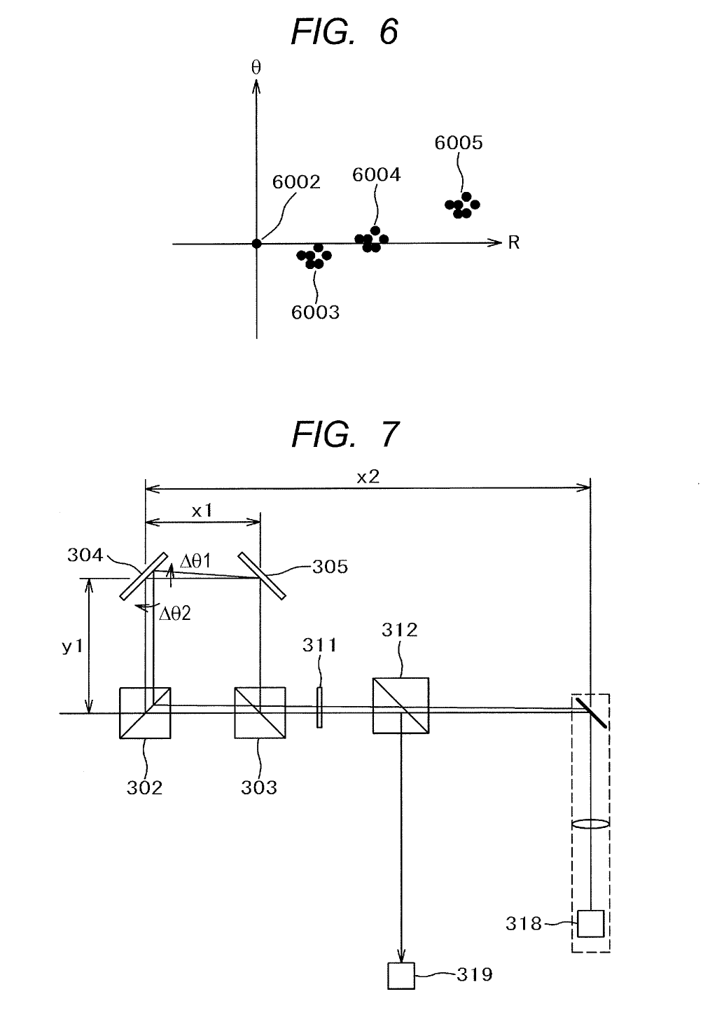

Further, a reference adjustment jig on which plural numbers of reference particles are splayed, such as, PSL or the like, is attached on a holder which holds a sample to be inspected. When detecting these reference particles by the defect determining portions 634 and 637 while using the illuminating and detecting systems, as described above, after finely determining a pitch in the “r” direction, fluctuation in detection made by an arbitrary defect determining portion fluctuates, as is in a graph shown in FIG. 6, upon basis of the position of the reference particles, in each defect determining portion. With calculating an averaged coordinate position of those fluctuations from 6002 to 6005 for these reference particles, it is possible to obtain a shift of the position of each pulse after the division thereof. Upon basis of this shift of each pulse, the distance is obtained in the “r” direction, among the spirals 1211 to 1214 shown FIG. 12, respectively, and although the data of the separate defect determining portions are associated or related with between them in the defect determining portions 634 to 637, but after being corrected in an amount of shift in this “r” direction. The similar process is also executed in the structure shown in FIG. 11. Thus, delay amounts in the FIFOs from 650 to 653 are corrected, as is shown in FIG. 6, upon basis of the amount of the shift in the e direction, which is detected for each pulse.

Heretofore, mentioning is made on the case of applying the laser light source of pseudo-continuous oscillation, upon an assumption of provision of a pulse dividing optical path for suppressing the instantaneous increase of temperature. Now, in case where the laser light source is one of a continuous oscillation type, then this pulse dividing optical path 8 is unnecessary; however, it is also possible to reduce the thermal damages, with scanning the illumination on the sample, by means of the deflector 701. An example of the structure of this instance is shown in FIG. 5B. Even with such structure shown in FIG. 5B, it can be deal with, when the scanning of the illumination in the “r” direction is desired, by applying the digital processor portion explained in FIG. 10B, while the digital processor portion explained in FIG. 11 when it is scanned in the θ direction. A relationship between an input control voltage to the deflector 701 and an amount of deflection is obtained, in advance, with using the reference adjustment jig splaying the reference particles shown in FIG. 6, and in the similar manner to that when dividing the pulse, setup of the defect determining portions 634 to 647 is made upon correspondences or relation in the θ direction, and also on interpolating coefficients in the interpolation in the “R” direction, or setup of delay mounts is made for each buffer.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

### DESCRIPTION OF MARKS

2 . . . light source, 3 . . . attenuator, portion, 5 . . . light flux enlargement, 6 . . . polarized light controller portion, 7 . . . illumination condense controller portion, 7v . . . illumination condense controller portion, 22 . . . beam monitor, 53 . . . beam monitor, 54 . . . display portion, 55 . . . input portion, 101 . . . illumination portion, 102 . . . detector portion, 103 . . . stage portion, 105 . . . signal processor portion, 120 . . . optical axis of illumination

What is claimed is:

1. A defect inspection apparatus, comprising:
a table which mounts a sample thereon and being able to rotate;
a laser light source which emits a pulse laser;
an illumination optical system which divides one pulse of the laser pulse emitted from the laser light source, thereby to irradiate upon the sample mounted on the table;
a detection optical system which detects a reflected light from the sample, being illuminated by irradiation of pulse lasers, which are divided into plural numbers thereof by dividing the one pulse by the illumination optical system;
a signal processing unit which processes an output signal from the detection optical system detecting the reflected light; and
an output unit which output a result of processing within the signal processing unit,
wherein the illumination optical system irradiates divided pulse laser, which are obtained by dividing the one pulse of the pulse laser into plural numbers thereof, respectively, upon separate positions on the sample.

2. The defect inspection apparatus, as described in the claim 1, wherein the illumination optical system irradiates the divided pulse laser, which are obtained by dividing the one pulse of the pulse laser into plural numbers thereof, upon plural numbers of positions differing from in a center direction of a center of rotation on the sample rotating on the table.

3. The defect inspection apparatus, as described in the claim 1, wherein the illumination optical system irradiates the divided pulse laser, which are obtained by dividing the one pulse of the pulse laser into plural numbers thereof, upon plural numbers of positions differing from in a direction of rotation on the sample rotating on the table.

4. The defect inspection apparatus, as described in the claim 1, wherein the illumination optical system comprises plural numbers of pulse dividing optical paths, each being different in optical length thereof, for dividing the one pulse of the pulse laser into plural numbers of pulses, and the pulse dividing optical paths shift the pulse lasers, each being divided when passing through each of the pulse dividing optical paths, respectively, thereby to be irradiated upon the separate positions on the sample.

5. The defect inspection apparatus, as described in the claim 1, wherein the illumination optical system comprises plural numbers of pulse dividing optical paths, each being different in optical length thereof, for dividing the one pulse of the pulse laser into plural numbers of pulses, and a beam driving portion for shifting optical axes of the pulse lasers, respectively, being divided when passing through the plural numbers of pulse dividing optical portions, for each of the pulse lasers divided.

6. The defect inspection apparatus, as described in the claim 5, wherein the beam driving portion is a deflector made up with an acousto-optical device.

7. The defect inspection apparatus, as described in the claim 1, wherein the illumination optical system comprises a monitor portion for monitoring the divided pulse lasers obtained by dividing the one pulse into plural numbers thereof.

8. A defect inspection method, comprising the steps of:
mounting a sample on a rotatable table to rotate;
irradiating a pulse laser emitted from a laser light source upon the rotating sample;
detecting a reflected light from the sample, upon which the pulse laser is irradiated;
detecting the reflected light from the sample; and
detecting a defect on the sample through processing of a signal obtained through the detection,
wherein irradiation of the pulse laser emitted from the laser light source upon the rotating sample is conducted by dividing the one pulse emitted from the laser light source into plural numbers of pulses, and irradiating each of the divided pulse lasers upon each of separate positions on the sample, respectively.

9. The defect inspection method, as described in the claim 8, wherein irradiating each of the divided pulse lasers upon each of separate positions on the sample, respectively, is conducted on plural numbers of positions, separated in direction of a center of rotation on the sample mounted and rotating on the table.

10. The defect inspection method, as described in the claim 8, wherein irradiating each of the divided pulse lasers upon each of separate positions on the sample, respectively, is conducted on plural numbers of positions, separated in direction of rotation on the sample mounted and rotating on the table.

11. The defect inspection method, as described in the claim 8, wherein dividing the one pulse laser emitted from the laser light source into plural numbers of pulses is conducted by entering the one pulse emitted from the laser light source into plural numbers of pulse dividing optical paths, each being different in length of an optical path, and irradiating each of the divided pulse lasers upon each of positions separated on the sample, respectively, is conducted by irradiating the pulse lasers, each being shifted in an optical axis thereof, respectively, after passing through the plural numbers of pulse dividing optical paths, to be irradiated on the positions separated on the sample.

12. The defect inspection method, as described in the claim 8, wherein dividing the one pulse laser emitted from the laser light source into plural numbers of pulses is conducted by entering the one pulse emitted from the laser light source into plural numbers of pulse dividing optical paths, each being different in length of an optical path, and irradiating each of the divided pulse lasers upon each of positions separated on the sample, respectively, is conducted by scanning optical axes of the pulse lasers, being divided after passing through the plural numbers of pulse dividing optical paths, respectively for each of the pulse lasers.

13. The defect inspection method, as described in the claim 12, wherein scanning optical axes of the pulse lasers, being divided after passing through the plural numbers of pulse dividing optical paths, respectively for each of the pulse lasers is conducted by a deflector made up from an acousto-optic element.

14. The defect inspection method, as described in the claim 8, wherein each of the divided pulse lasers, which are obtained by dividing the one pulse into plural numbers of pulses, is imaged to be monitored.
